(19) United States
(12) Patent Application Publication
(10) Pub. No.: US 2026/0194160 A1
(43) Pub. Date: Jul. 9, 2026

(54) GAS PURGE PLUG AND SYSTEM FOR EASY INSTALLATION OF THE GAS PURGE PLUG IN A METALLURGICAL VESSEL

(71) Applicant: Vesuvius Group, S.A., Ghlin (BE)

(72) Inventors: Matthew McKinney, Ghlin (BE); John Walker, Ghlin (BE); Jeffrey Insana, Ghlin (BE)

(73) Assignee: Vesuvius Group, S.A., Ghlin (BE)

(21) Appl. No.: 19/131,621

(22) PCT Filed: Nov. 23, 2023
(86) PCT No.: PCT/EP2023/082890

§ 371 Date: May 21, 2025

(30) Foreign Application Priority Data
Nov. 25, 2022 (EP) 22209663.8

(51) Int. Cl. F16K 51/00; B22D 1/00; F16K 24/04; F16K 27/00; F27D 3/16

(52) U.S. Cl. CPC F16K 51/00; B22D 1/005; F16K 24/04; F16K 27/00; F27D 3/16

(57) ABSTRACT

A kit or system for installation of a gas purge plug (1) in an opening (15) in a wall (11w) of a metallurgical vessel (11) is provided. The system includes: a gas purge plug equipped with a plug coupling element (1c), and an insertion rod (2) equipped with a rod coupling element (2c) complementary with the plug coupling element (1c) to assemble the gas purge plug and insertion rod to form a rigid plug/rod assembly extending along a longitudinal axis (X). A rail assembly configured for receiving the plug/rod assembly and for guiding the gas purge plug into an opening at an accurate operational position is also provided. The insertion rod (2) is also equipped with at least two locking blades (2b) configured for engaging into corresponding catcher elements (12) provided at a periphery of the opening (15).

### TECHNICAL FIELD

The present invention concerns a gas purge plug designed for facilitating an installation thereof into an opening through a wall of a metallurgical vessel. The gas purge plug and associated tools of the present invention form a system allowing the gas purge plug to be precisely and reproducibly fixed to the operational position thereof with reduced human intervention time.

### BACKGROUND OF THE INVENTION

Gas purging, flushing or washing of molten metal in metallurgical vessels during production of metal and metal parts has various advantageous effects known in the art. Typically, the main objective of sparging in molten metal is to stir the molten metal in the metallurgical vessel such as a ladle. This yields inter alia the following effects: desulfurization, reduction of non-metallic inclusions, uniform distribution of temperature and alloy additives, steel cleanliness, and the like.

As shown in FIG. 1(b), the gas (1g) can be sparged into the molten metal (21) through a gas purge plug (1) fixed in an opening of a wall of the metallurgical vessel (11) extending from an outer wall in the exterior of the vessel to an inner wall in the interior of the vessel containing the molten metal. The gas purge plug has a gas inlet coupled to a source of gas (1s), such as nitrogen, argon, and the like, which is in fluid communication with a gas outlet located at the level of the inner wall when fixed at the plug operational position. The gas purge plug is fixed to the opening in the wall by means of a refractory mortar acting as an adhesive.

Gas purge plugs need be replaced when worn or partially obstructed by frozen metal. A spent plug must then be removed from the opening by breaking the adhesive joint formed by the refractory mortar. For example, WO9200392, DE102005018021, and EP2343386 describe pull-out devices for pulling a spent plug out of the opening. Once the spent plug is removed, the opening is cleaned, and a new gas purge plug coated with fresh refractory mortar can be inserted into the opening and fixed therein at the operational position as soon as the refractory mortar has set. Insertion of a new gas purge plug is generally made mostly manually, which is a man-time intensive operation with limited control on the exact positioning of the plug in the opening.

U.S. Pat. Nos. 4,978,108 and 5,056,762 describe a device for handling a gas purge plug in and out of an opening in a metallurgical vessel comprising a double-hinged structure permanently fixed to the outer wall of the metallurgical vessel.

DE10114467 describes a pull-out device that can also be used to insert a gas purging plug into the opening. A new plug is coupled to an insertion rod and the device comprises a tripod provided with a centring ring, which serves to fix the insertion rod in alignment with the opening axis. The new plug is driven into the opening until reaching the operating position by means of a hydraulic piston, which renders the whole system quite cumbersome to install and use.

U.S. Pat. No. 5,333,843 describes a device for pulling out a spent plug and for inserting a new one into an opening through a metallurgical vessel wall. The device comprises hinges permanently attached to the outer wall of the vessel to pivot the new plug in and out of axial alignment with the opening, and a guide tube for axially displacing the plug into the opening. To drive the displacement along the guide tube, the device is equipped with a compressed-air hammer attached to the guide tube. Again, with the compressed air hammer and the hinges permanently fixed to the metallurgical vessel, this device is quite cumbersome to use.

DE102005018020 describes a device for inserting a gas purge plug into an opening in a wall of a metallurgical vessel. The gas purge plug is coupled to an insertion rod whose longitudinal axis is brought coaxial with an opening axis by means of first and second threaded pistons which positions are controlled by rotating the threaded pistons. The gas purge plug can be moved into the opening by rotating a third threaded piston coaxial with the opening axis.

The foregoing devices are heavy-set and cumbersome to handle; requiring a hydraulic piston, a compressed air hammer, or a slow-moving rotating threaded spindle to translate the plug along the opening axis into the opening until reaching the operating position of the plug.

There therefore remains a need for gas purge plugs and light-set devices for easily, reproducibly, and accurately inserting a new gas purge plug into an opening at the operating position and requiring no human intervention during the setting of the refractory mortar. The present invention proposes such gas purge plug and device fulfilling these requirements. These and other advantages are described in detail in the following sections.

Document JPH07305967A discloses a method for conveying a porous plug to a nozzle cradle of a molten metal container and attaching it to the nozzle cradle or removing an old porous plug.

Document U.S. Pat. No. 4,670,958A discloses a device for extracting a sheet-metal-encased gas-purge brick from a perforated brick of a metallurgical vessel. The device consists of a frame adapted to rest upon the exterior of the perforated brick; a drawbar displaceable axially in the frame in relation to the metallurgical vessel and adapted to be set up in alignment with the centerline of the gas-purge brick; a device, provided on the drawbar, for coupling the end thereof to the gas-purge brick; and a driving means for displacing the drawbar in a direction away from the perforated brick.

Document EP1728876A2 discloses a purging plug extractor using a coupling designed in the manner of a bayonet lock.

### SUMMARY OF THE INVENTION

The appended independent claims define the present invention. The dependent claims define preferred embodiments. In particular, the present invention concerns a kit of parts for installing a gas purging plug into a metallurgical vessel comprising a gas purging plug for blowing gas into a metallurgical vessel, the gas purging plug comprising:
(a) an elongated body made of a refractory material, inscribed in a volume of revolution about a plug axis (X1), wherein the elongated body extends from an inlet end comprising a gas inlet to an outlet end comprising a gas outlet along the plug axis (X1),
(b) at least one gas flow path fluidly connecting the gas inlet to the gas outlet.

The kit-of-parts also comprises an insertion rod and at least two locking blades extending normal to the longitudinal axis at a predefined distance from the coupling end and distributed around a circumference of the elongated staff. The locking blades are used for fixing the purge/rod assembly into the operational position of the gas purging plug for the time required for the refractory mortar to set. The insertion rod preferably comprises two, three or four locking blades.

The gas purging plug comprises a plug coupling element located at the inlet end, coaxial with the plug axis and configured for forming a rigid mechanical coupling with a mating rod coupling element.

The plug coupling element of the present invention is configured for forming the rigid mechanical coupling with the mating rod coupling element by rotation of one relative to the other about the plug axis (X1) by a rod coupling angle, 5≤°α≤80°, preferably 10°≤α≤75°.

The insertion rod comprises:
an elongated staff extending from a staff coupling end to a staff second end along a rod axis (X2),
a rod coupling element located at the staff coupling end and configured for mating the plug coupling element to form a purge/rod assembly comprising the insertion rod rigidly coupled to the gas purging plug with the rod coupling element rigidly and reversibly mechanically coupled to the plug coupling element.

The rod coupling element and the plug coupling element are configured for rigidly coupling and decoupling to and from one another with the plug axis (X1) being coaxial with the rod axis (X2) defining a longitudinal axis (X), by first a translation of one relative to the other along the longitudinal axis (X) followed by a rotation about the longitudinal axis by a rod coupling angle, 5≤α≤80°, preferably 10°≤α≤75°.

The at least two locking blades are part of the insertion rod.

According to the present invention, the insertion rod is configured for being rotated by a plug locking angle of up to β°≥α, to engage the at least two locking blades into the catcher elements and thus reversibly lock the gas purging plug in the operational position.

The gas purging plug and the rod can thus be easily assembled, for example by an operator translating and rotating one with respect to each other, to form a purge/rod assembly.

The rod coupling element and the plug coupling element can comprise a male element and a female element, wherein
the male element comprises a base of geometry of revolution about the longitudinal axis (X) and
the female element comprises a cavity of geometry of revolution about the longitudinal axis (X) with a first radius mating the base of the male element, and configured for accepting introduction of the male base into the cavity,

In a preferred embodiment, the rod coupling element and the plug coupling element are of a key-lock type, wherein
the base of the male element is provided with protrusions distributed about a circumference of the base and preferably along the longitudinal axis (X), defining a key, the protrusions having a protrusion thickness measured along the longitudinal axis (X), and wherein
the cavity of the female element comprises recesses located at an opening of the cavity and mating the corresponding protrusions of the male element, and a circumferential channel located deeper in the cavity along the longitudinal axis (X), beyond the recesses, the channel having a second radius, larger than or equal to a sum of the first radius and of a radial dimension of any recess and having a channel thickness measured along the longitudinal axis (X) which is larger than or equal to the protrusion thickness, the female element forming a lock configured for allowing insertion of the male element into the cavity for a finite number of angular positions wherein the protrusions of the male element are in registration with corresponding recesses of the female element, until the protrusions reach the channel and for allowing a rotation by the rod coupling angle, a, of the male element relative to the female element such as to bring the protrusions out of registration from the recesses to rigidly and reversibly mechanically couple the rod coupling element to the plug coupling element.

In an alternative embodiment, the rod coupling element and the plug coupling element are of a bayonet type, wherein
the base of the male element is provided with a number of protrusions aligned along the longitudinal axis (X), and wherein,
the cavity of the female element comprises a longitudinal slit extending parallel to the longitudinal axis (X) and is configured for receiving in a sliding relation the number of protrusions and comprises a number of transverse slits at least equal to the number of protrusions, starting from the longitudinal slit and extending parallel to one another and transversally to the longitudinal axis (X), the female element being configured for allowing insertion of the male element into the cavity with the number of protrusions sliding along the longitudinal slit, until each of the number of protrusions reaches the corresponding number of transverse slits and for allowing a rotation by the rod coupling angle, a, of the male element relative to the female element such as to insert the number of protrusions along the corresponding transverse slits to rigidly and reversibly mechanically couple the rod coupling element to the plug coupling element.

The present invention also concerns a metallurgical installation comprising a kit-of-parts as defined supra and a metallurgical vessel. It preferably also comprises a rail assembly and a shuttle.

The metallurgical vessel comprises a wall comprising an inner wall separated from an outer wall by a thickness of the wall, wherein
the wall comprises an opening extending along an opening axis (X15) from the outerwall to the inner wall and configured for introducing the elongated body of the gas purge plug into the opening by the outerwall, and for accommodating and rigidly fixing the gas purge plug ( ) at an operational position with the plug axis (X1) coaxial with the opening axis (X15), and maintained in the operational position with a refractory mortar,
on at least two opposite sides of the opening, the outer wall comprises catcher elements configured for interacting with the at least two locking blades such as to lock the gas purge plug in the operational position along the opening axis (X15).

The purge/rod assembly can thus be easily assembled with the metallurgical vessel, for example by an operator translating and rotating one with respect to each other, to be in a configuration where the refractory mortar sets and glues the purge, but not the rod, to the metallurgical vessel. Once the refractory mortar has set, the rod can be rotated back, by a plug unlocking angle −β, to unlock from the metallurgical vessel and from the gas purge plug in only one motion. This unlocking back rotation can easily be performed by an operator. The rod is then translated away from the vessel/purge assembly.

In a preferred embodiment, the number of catcher elements on the outer wall is lower than the number of locking blades on the insertion rod. This decreases the angle that the insertion rod has to rotate, in average, to engage the locking blades into the catcher elements.

In an embodiment, on at least two opposite sides of the opening, the outer wall comprises rail fixing elements configured for reversibly receiving and rigidly holding in place a rail assembly, and the metallurgical installation comprises the rail assembly, which comprises:
at least one rail, preferably two rails parallel to one another, each rail extending from a rail coupling end to a rail free end, and
wall fixing elements mating the rail fixing elements of the wall of the metallurgical vessel, located at the rail coupling end and configured for rigidly fixing the rail assembly to the wall with the at least one rail extending parallel to the opening axis (X15). The rail assembly ensures that the plug/rod assembly can be driven coaxially with the opening axis (X15) into the opening.

The metallurgical installation comprises a shuttle, which comprises a shuttle coupling fixture configured for receiving and coupling the staff of the insertion rod, and is configured for:
moving the insertion rod to bring and preferably lock the staff and gas purging plug rigidly coupled thereto to a position wherein the longitudinal axis (X) is coaxial with the opening axis (X15) with the gas purging plug facing the opening, and
translating along the at least one rail to insert along the opening axis (X15) the gas purging plug into the opening until reaching the operational position, with the at least two locking blades of the insertion rod contacting the wall of the metallurgical vessel.

The shuttle coupling fixture is preferably configured to allow the staff to rotate from a position wherein the longitudinal axis (X) is substantially perpendicular to the opening axis (X15), to a position wherein the longitudinal axis (X) is parallel to the at least one rail and is coaxial with the opening axis (X15). The shuttle coupling fixture may be coupled to a staff coupling fixture of the staff is such a way that, in the position wherein the longitudinal axis (X) is substantially perpendicular to the opening axis (X15), the staff is hold by the shuttle coupling fixture.

The shuttle preferably comprises at least one sleeve surrounding the at least one rail in such a way that the shuttle is able to slide along the at least one rail during the translation.

The rail fixing elements and the rail assembly are such that the at least one rail does not move during the translation of the shuttle.

The present invention also concerns a method for inserting a gas purging plug into an opening extending along an opening axis (X15) from an outerwall to an innerwall of a metallurgical vessel, and for reproducibly positioning and fixing the gas purging plug to an operational position in the gas purging plug comprising
providing a metallurgical installation as defined supra,
preferably rigidly fixing the rail assembly to the wall by engaging the wall fixing elements into the rail fixing elements of the wall of the metallurgical vessel,
forming a plug/rod assembly by rigidly coupling the gas purging plug to the insertion rod with the plug axis (X1) coaxial with the rod axis (X2) defining the longitudinal axis (X), by first translating and then rotating by the rod coupling angle α the rod coupling element relative to the plug coupling element,
preferably coupling the staff of the insertion rod to the shuttle coupling fixture of the shuttle,
applying the refractory mortar to an external surface of the elongated body of the gas purging plug,
moving by rotation the plug/rod assembly to bring and preferably lock the plug/rod assembly to a position wherein the longitudinal axis (X) is coaxial with the opening axis (X15) with the gas purging plug facing the opening,
preferably translating the shuttle along the at least one rail,
inserting along the opening axis (X15) the gas purging plug into the opening until the at least two locking blades of the insertion rod contact the wall of the metallurgical vessel, thus defining the operational position,
rotating the insertion rod about the longitudinal axis (X) by a plug locking angle of up to β°≥α, to engage the at least two locking blades into the catcher elements and thus reversibly lock the gas purging plug in the operational position,
allowing the refractory mortar to set,
rotating the insertion rod by a plug unlocking angle −β, to disengage the at least two locking blades from the catcher elements and to decouple the insertion rod from the gas purging plug which is fixed to the opening at the operational position by the refractory mortar.

### BRIEF DESCRIPTION OF THE FIGURES

For a fuller understanding of the nature of the present invention, reference is made to the following detailed description taken in conjunction with the accompanying drawings in which:

FIG. 1(a): shows an example of metallurgical installation comprising a ladle equipped with a gas purge plug according to the present invention, a tundish, and a mould.

FIG. 1(b): shows a detail of a cross-sectional view of a metallurgical vessel equipped with a gas purge plug according to the present invention.

FIG. 2(a): shows a first embodiment of a gas purge plug provided with a key-lock type purge coupling element according to the present invention.

FIGS. 2(b) and 2(c): show cross-sectional views of two embodiments of the male elements of a key-lock type coupling element as in FIG. 2(b).

FIGS. 2(d) and 2(e): show cross-sectional views of two embodiments of the female elements of the key-lock type coupling elements of FIGS. 2(b) and 2(c).

FIGS. 2(f) and 2(g): show partially cut perspective views of the female elements of the key-lock type coupling elements of FIGS. 2(d) and 2(e).

FIG. 3(a) to 3(c): shows a second embodiment of a gas purge plug provided with a bayonet type purge coupling element according to the present invention (a) plug separated from rod, (b) insertion of male element into cavity of the female element by translation along X, (c) locking the coupling by rotation by the rod coupling angle, a.

FIG. 4(a): shows the various separate components of a kit-of-parts according to the present invention, including a gas purge plug, an insertion rod, and a rail assembly, for inserting the gas purge plug into an opening in a wall of a metallurgical vessel.

FIG. 4(b): shows the components of FIG. 4(a) in an assembled configuration with the rail assembly fixed to the outer wall of the metallurgical vessel, and the longitudinal axis (X) of the gas purge plug and insertion rod coaxial with the opening axis (X15) and with the gas purge plug partially inserted in the opening. The coordinate system (x, y, z) applies to all of FIGS. 4(a) to 4(d).

FIG. 4(c): shows the assembled components of FIG. 4(b), with the gas purge plug at the operating position thereof with the locking blades contacting the outer wall but not engaged into the catcher elements.

FIG. 4(d): shows the assembled components of FIG. 4(c), with the gas purge plug position along the longitudinal axis (X) locked by rotation of the locking blades engaging the corresponding catcher elements.

FIG. 5: shows various steps for inserting and fixing a gas purge plug according to the present invention into an opening of a metallurgical vessel wall, including FIG. 5(a): providing a clean opening, a new gas purge plug, an insertion rod, and a rail assembly (not shown).

FIG. 5(b): coupling the insertion rod to the gas purge plug by a translation/rotation movement, fixing the rail assembly to the outer wall of the metallurgical vessel, coupling the insertion rod to the shuttle and coating the outer surface of the gas purge plug with a fresh refractory mortar.

FIG. 5(c): moving/tilting the plug/rod assembly until the longitudinal axis (X) becomes coaxial with the opening axis (X15).

FIG. 5(d): translating the shuttle with plug/rod assembly into the opening until reaching the plug's operating position which is reached when the locking blades contact the outer wall.

FIG. 5(e): rotating the plug/rod assembly by an angle β to engage the locking blades into the catcher elements to lock the position of the plug/rod assembly along the longitudinal axis (X). Waiting until the refractory mortar sets.

FIG. 5(f): disengaging the locking blades from the catcher elements and simultaneously uncoupling the insertion rod from the plug by rotating the insertion rod by an angle −β. Removing the insertion rod and the rail assembly.

FIG. 5(g): Connecting a gas tube between the plug inlet and a gas source.

FIG. 6(a): shows an embodiment of locking blades engaged in catcher elements.

FIG. 6(b) to 6(e) show side views of four embodiments of geometries of locking blades and catcher elements.

### DETAILED DESCRIPTION OF THE INVENTION

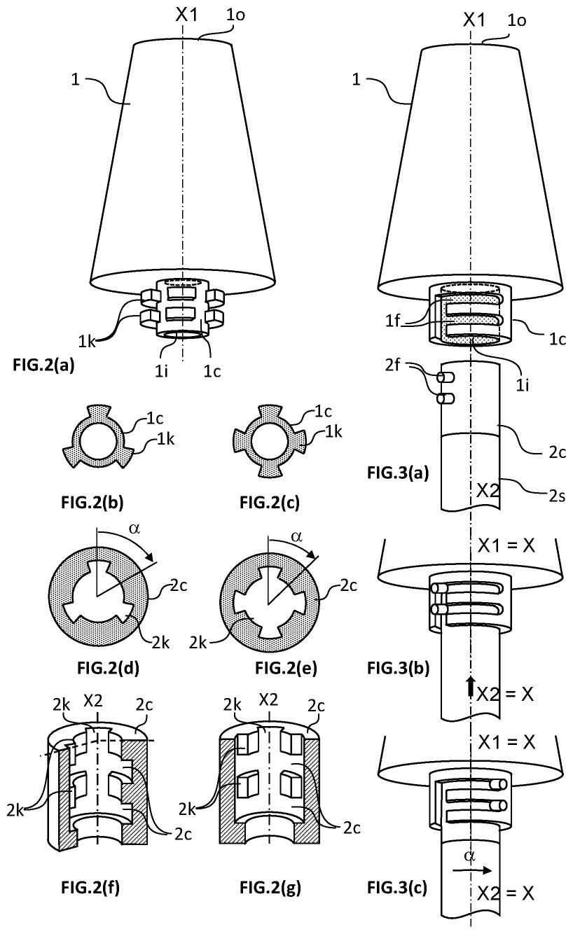

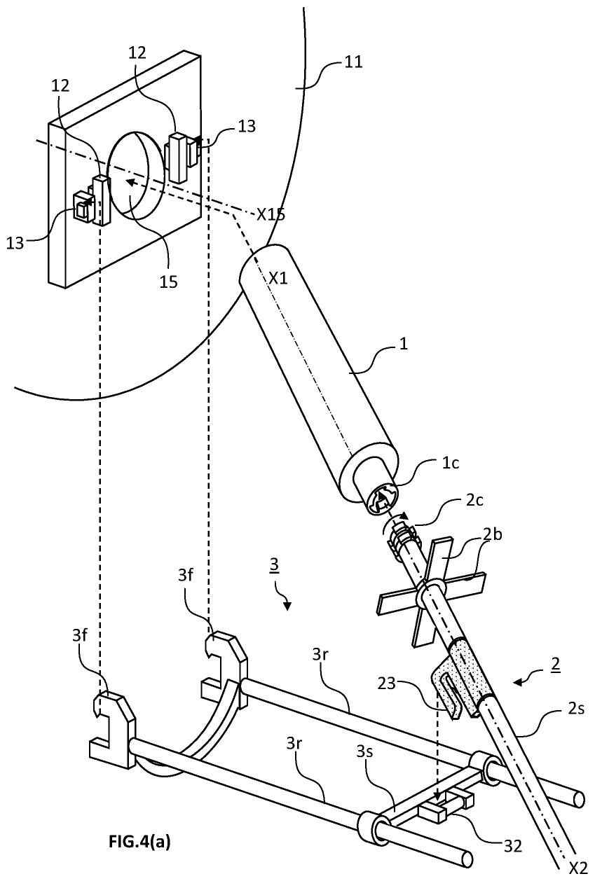

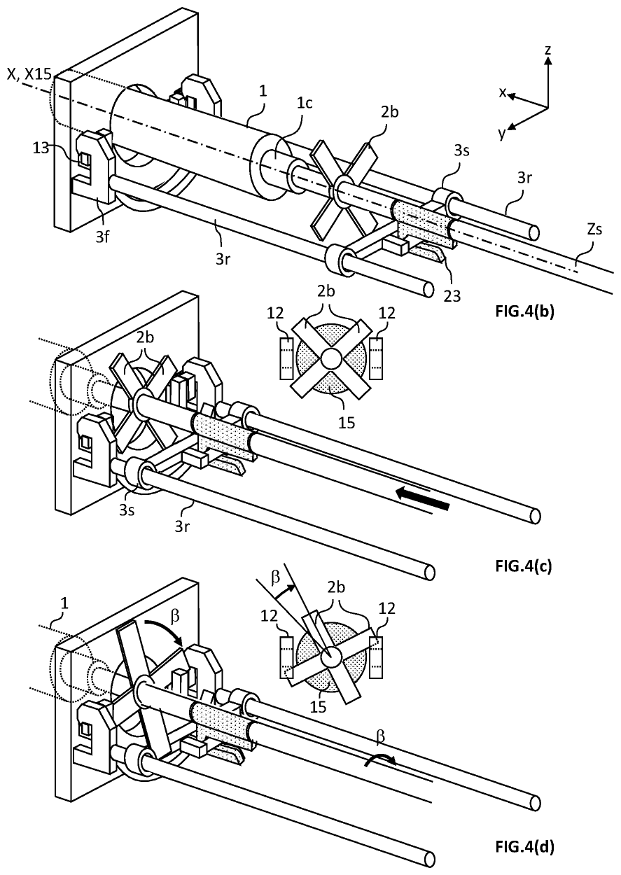

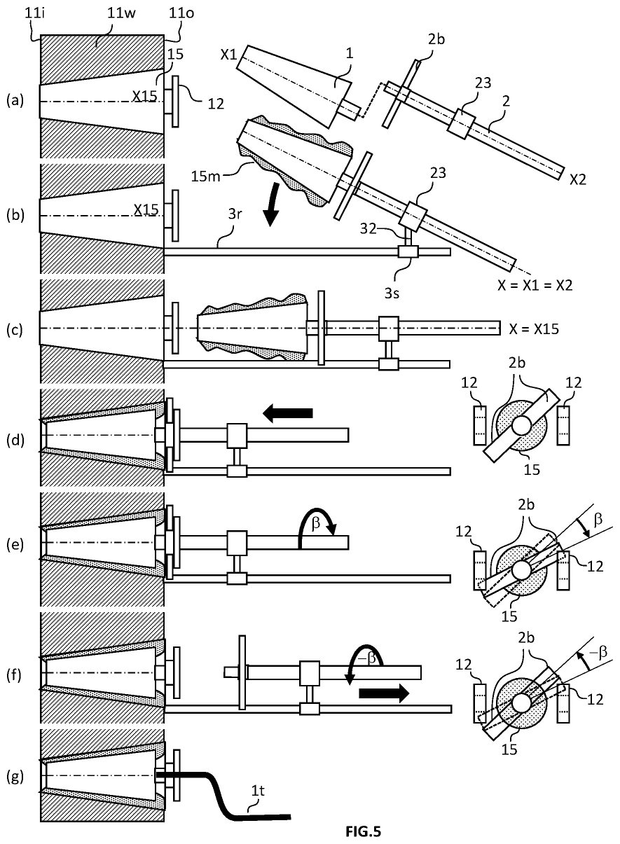

As illustrated in FIG. 2(a), the present invention concerns a gas purge plug provided with a specific plug coupling element (1c). As illustrated in FIGS. 3(a) to 3(c), it also concerns a kit-of-parts and assembly comprising the foregoing gas purge plug and an insertion rod comprising a specific rod coupling element (2c) mating the specific plug coupling element (1c), which are configured for reversibly rigidly coupling the insertion rod to the gas purge plug. As shown in FIGS. 4 and 5, the kit-of-parts comprises various components configured for accurately and reproducibly inserting the gas purge plug into an opening in a wall of a metallurgical vessel into the operating position thereof. Finally, the present invention also concerns a method for accurately and reproducibly inserting the gas purge plug into an opening in a wall of a metallurgical vessel into the operating position thereof and fixing it as said operational position with a refractory mortar (15m), as illustrated in FIG. 5.

### Gas Purge Plug (1)

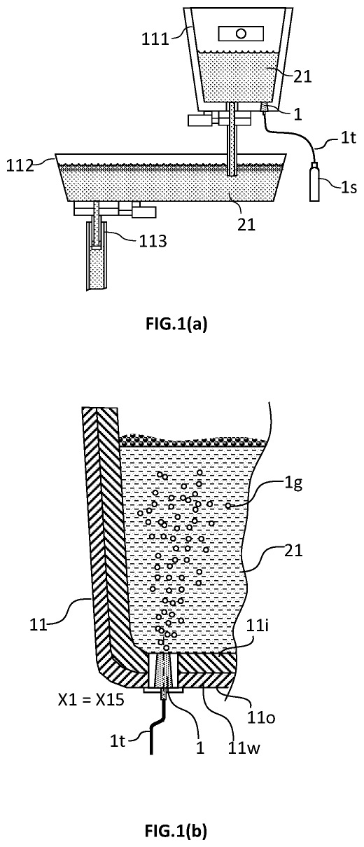

A gas purge plug (1) according to the present invention is used to sparge gas, such as nitrogen or argon into molten metal contained in a metallurgical vessel, such as a ladle (111) as illustrated in FIG. 1(a), wherein the ladle (111) continuously fills the tundish (112) as molten metal is continuously cast into the mould (113). As shown in FIG. 2(a) a gas purge plug has an elongated body made of a refractory material, inscribed in a volume of revolution about a plug axis (X1). The elongated body generally has a trunco-conical geometry, extending from a plug inlet (1i) located at a broad, inlet end to a plug outlet (10) located at a narrow, outlet end of the body. The gas purge plug comprises at least one gas flow path fluidly connecting the gas inlet (1i) to the gas outlet (10). The gas outlet (10) may be along the plug axis (X1). Various designs are known in the art, with the at least one flow path being formed by an open pore structure, or by a network of slots or channels. The plug inlet (1i) is configured for being coupled to a gas tube (1t) coupled to a gas source (1g) (cf. FIGS. 1(a), 1(b), and 5(g). The elongated body of the gas purge plug is made of a refractory material, generally by sintering.

The gas purge plug is configured for being inserted and fixed at an operational position in an opening (15) extending through a wall (11w) of a metallurgical wall. Generally, the wall (11W) is a bottom floor of the metallurgical vessel (e.g., a ladle). The opening extends through the wall from an outer wall (11o) defining an exterior of the metallurgical vessel to an inner wall (11i) defining an interior of the vessel, which in use is in contact with the molten metal. The opening (15) can be formed by a hole in a brick but is often formed by a sleeve inserted in a hole in a brick as illustrated schematically in FIG. 1(b). A sleeve gives a better control of the geometry of the opening. The sleeve can also preferably comprise or be fixed to flanges extending over the outer wall (11w) of the metallurgical vessel which can be equipped with different fixtures such as catching elements (12) and rail fixing elements (13). Because of high temperatures, severe temperature gradients, high gas pressure and flowing velocity, and high turbulences at the level of the downstream end in contact with the molten metal, the structure of the gas purge plug is sensitive to wear and needs be changed at regular intervals.

As discussed supra, several solutions are available in the art for inserting a new gas purge plug (1) into an opening (15). The present invention uses a solution comprising the use of an insertion rod (2) which is to be coupled to the inlet end of the gas purge plug (1). To this effect, as shown in FIGS. 2(a) to 2(g) and FIGS. 3(a) to 3(c), the gas purge plug (1) comprises a plug coupling element (1c) located at the inlet end of the plug, coaxial with the plug axis (X1) and configured for forming a rigid mechanical coupling with a mating rod coupling element (2c) provided at one end of the insertion rod (2), to form a plug/rod assembly extending along a longitudinal axis (X). The plug coupling element (1c) must not be confused with the connection of the gas inlet (1i) of the gas purge plug (1) with a gas tube (1t) for feeding the plug with gas from a gas source (1s).

Traditionally, the coupling mechanism between the purge coupling element (1c) and the rod coupling element (2c) consists of a threaded male element configured for being screwed into a threaded female element. To yield a rigid coupling of the insertion rod (2) to the gas purge plug (1) and thus yield a rigid plug/rod assembly with such thread coupling mechanism requires the insertion rod to rotate by several revolutions (i.e., N×360° with N>1). This would not be a problem per se, but the use of locking blades (2b) mounted on the insertion rod (2) to lock the position along the longitudinal axis (X) of the plug in the operating position as will be discussed in continuation is incompatible with a plug/rod coupling mechanism requiring the rotation of one relative to the other by more than a plug unlocking angle −β.

The gas purge plug of the present invention therefore comprises a plug coupling element (1c) configured for forming the rigid mechanical coupling with the mating rod coupling element (2c) of the insertion rod (2) by rotation of one relative to the other about the plug axis (X1) by a rod coupling angle, 5≤°α≤80°, preferably 10°≤α≤75°. With these ranges, the rod coupling angle (α) is smaller than the absolute value of the unlocking angle |−β|, which makes it compatible with the use of locking blades (2b) discussed in continuation.

### Plug/Rod Assembly

As explained supra, the present invention uses an insertion rod (2) to insert a new gas purge plug into an opening of a metallurgical vessel. The insertion rod (2) comprises an elongated staff (2s) extending from a staff coupling end to a staff second end along a rod axis (X2). The staff second end may be a staff free end. The rod comprises a rod coupling element (2c) located at the staff coupling end, As explained supra, the rod coupling element (2c) is configured for mating the plug coupling element (1c) of the gas purge plug (1) to form a plug/rod assembly comprising the insertion rod (2) rigidly coupled to the gas purging plug (1) with the rod coupling element (2c) rigidly and reversibly mechanically coupled to the plug coupling element (1c), and with the rod axis (X2), being coaxial with the purge axis (X1) and defining a longitudinal axis (X) of the plug/rod assembly.

The coupling of the insertion rod (2) to the gas purge plug (1) is formed by first translating one relative to the other along the longitudinal axis (X) followed by a rotation about the longitudinal axis by the rod coupling angle, 5≤α≤80°, preferably 10°≤α≤75°.

The rod coupling element (2c) and the plug coupling element (1c) preferably comprise a male element and a female element allowing the translation along the longitudinal axis (X) of the male element into a cavity of the female element. In this embodiment, the male element comprises a base of geometry of revolution about the longitudinal axis (X) and the female element comprises the cavity of geometry of revolution about the longitudinal axis (X) with a first radius mating the base of the male element and configured for accepting introduction of the male base into the cavity. Several solutions are available for forming a rigid coupling of the gas purge plug and insertion rod once the male element is inserted in the female element.

In one embodiment illustrated in FIGS. 2(a) to 2(g), the rod coupling element (2c) and the plug coupling element (1c) are of the key-lock type. As shown in FIGS. 2(a) to 2(c), the base of the male element is provided with protrusions (1k) distributed about a circumference of the base and preferably along the longitudinal axis (X), defining a key. The protrusions can be distributed about the circumference of the base forming a single row or, as shown in FIGS. 2(a) to 2(c), over two (or more) rows separated from one another by circumferential channels. The protrusions (1k) have a protrusion thickness measured along the longitudinal axis (X).

As shown in FIGS. 2(d) to 2(g), the cavity of the female element comprises recesses (2k) located at an opening of the cavity and mating the corresponding protrusions (1k) of the male element like a key and a lock. The cavity further comprises a circumferential channel (2c) located deeper in the cavity along the longitudinal axis (X), beyond the recesses. In case the male element comprises protrusions distributed over two rows, than the cavity of the female element comprises a second set of recesses followed by a channel to receive the second row of protrusions (1k) as shown in FIGS. 2(f) and 2(g). The channel has a second radius, larger than or equal to a sum of the first radius and of a radial dimension of any recess and having a channel thickness measured along the longitudinal axis (X) which is larger than or equal to the protrusion thickness. The female element forms a lock configured to allow insertion of the male element into the cavity for a finite number of angular positions wherein the protrusions of the male element are in registration with corresponding recesses of the female element, until the protrusions reach the channel. At this stage, a rotation by the rod coupling angle, a, of the male element relative to the female element brings the protrusions out of registration from the recesses to rigidly and reversibly mechanically couple the rod coupling element (2c) to the plug coupling element (1c), In a preferred embodiment, a width of the channel measured along the longitudinal axis (X) can be tapered, so as to lock the protrusions (1k) as they are being rotated along the tapering channel.

In a second embodiment illustrated in FIGS. 3(a) to 3(c), the rod coupling element (2c) and the plug coupling element (1c) are of the bayonet type. As shown in FIG. 3(a), the base of the male element is provided with a number of protrusions (2f) aligned along the longitudinal axis (X),

The cavity of the female element comprises a longitudinal slit extending parallel to the longitudinal axis (X) and is configured for receiving in a sliding relation the number of protrusions (2k), allowing the translation of the insertion rod (2) relative to the gas purge plug (1) along the longitudinal axis (X), as shown in FIG. 3(b). The female cavity also comprises a number of transverse slits (1f) at least equal to the number of protrusions, starting from the longitudinal slit and extending parallel to one another and perpendicular to the longitudinal axis (X). The transverse slits (1f) must be separated from one another by the same distance separating the protrusions of the male element so that when the protrusions translate along the longitudinal slit until coming into registration with the corresponding transverse slits (1f) the male element can be rotated to insert the protrusions into the transverse slit and to translated them along the transverse slits (1f) as shown in FIG. 3(c).

As shown in FIG. 3(c), the male component can thus be rotated by the rod coupling angle, a, relative to the female element, the protrusions travelling along the corresponding transverse slits to rigidly and reversibly mechanically couple the rod coupling element (2c) to the plug coupling element (1c).

In a preferred embodiment of the present invention, the insertion rod (2) is provided with at least two locking blades (2b) extending normal to the longitudinal axis at a predefined distance from the coupling end and distributed around a circumference of the elongated staff. Preferably, the insertion rod (2) comprises three or four such locking blades (2b) uniformly distributed around the circumference of the elongated staff (2s). The functions of the locking blades (2b) are essential to the method of the present invention which is discussed in continuation.

The staff (2s) preferably comprises a staff coupling fixture (23) configured for coupling the staff to a corresponding shuttle coupling fixture (32) described in continuation. The staff (2s) is free to rotate about the rod axis (X2) relative to the staff coupling fixture (23) by at least a plug locking angle (β). This is easily achieved by e.g., mounting the shuttle coupling fixture (32) on a sleeve surrounding the staff (3s) albeit prevented from moving along the rod axis (X2), as shown in FIGS. 4(a) to 4(d). The sleeve can be equipped with bearings to facilitate rotation of the staff (3s) relative to the staff coupling fixture (32).

### Plug Positioning and Insertion Components

The insertion rod (2) coupled to the gas purge plug (1) and forming together the plug/rod assembly can be handled manually by an operator to insert the gas purge plug coated with fresh refractory mortar (15m) into the opening (15). This operation, however, has but little control on the accuracy and reproducibility of the positioning of the plug relative to the opening. Furthermore, the operator must hold the gas purge plug in place until the refractory mortar (15) sets because the fresh refractory mortar, squeezed in a gap defined between the elongated body of the gas purge plug and the wall of the opening tends to push the gas purge plug out of the opening. During this setting time, the operator cannot attend to any other duty. The gas/plug assembly of the present invention is, however, configured for interacting with a number of positioning and insertion components to ensure an accurate and reproducible positioning of the gas purge plug (1) relative to the opening (15) with reduced manual intervention. The components include,
(1) a rail assembly (3)
(2) rail fixing elements (13) attached to the outer wall (11o) of the metallurgical vessel (11),
(3) catcher elements (12) to interact with the locking blades (2b) and attached to the outer wall (11o) of the metallurgical vessel (11),

### Outer Wall (11o) of the Metallurgical Vessel (11)

The wall (11) comprises an opening (15) extending along an opening axis (X15) from the outer wall (11o) to the inner wall (11i). As discussed supra, the opening (15) is configured for receiving the elongated body of the gas purge plug (1) which is to be introduced from the outer wall (11o), because of the substantially trunco-cylindrical geometry of the elongated body. The gas purge plug (1) is to be accommodated and rigidly fixed in the opening (15) at an operational position with the plug axis (X1) coaxial with the opening axis (X15). The gas purge plug (1) is maintained in the operational position when the refractory mortar (15m) has set,

The outer wall (11o) of the metallurgical vessel (11) which comprises the opening (15) must be equipped with rail fixing elements (13) and catcher elements (12). These components are preferably made of metal and can be fixed at the circumference of the opening (15) directly to the outer wall (11o) of the metallurgical vessel (11) or, if the opening (15) is defined by a sleeve, they can be mounted on a flange surrounding the opening (15) and covering or defining a portion of the outer wall (11o). In the latter case, the flange of the sleeve covering a portion of the outer wall is considered herein as defining that portion of the outer wall (11o) of the metallurgical vessel (11). The term “outer wall” (11o) is therefore used herein as the outermost surface of the metallurgical vessel, regardless of whether it is defined by a portion of a sleeve or by a flange thereof. IN a preferred embodiment, the outer wall (11o) surrounding the opening (15) is formed by a flange made of metal and supporting the rail fixing elements (13) and catcher elements (12), also made of metal. The outer wall must have a planar portion surrounding the opening and perpendicular to the opening axis (X15). The planar portion must extend at least over an area scanned by the locking blades (2b) when they are rotated in contact with the planar portion.

The insertion system of the present invention uses a rail assembly (3) for guiding the introduction of the gas purge plug until reaching the operating position thereof inside the opening (15). The rail assembly (3) can be fixed to the outer wall when a new gas purge plug is to be inserted into the opening (15) and can be removed when the insertion operation is over. The rail fixing elements (13) are configured for cooperating with wall fixing elements (3f) of the rail assembly (3) and for reversibly and rigidly fixing the rail assembly (3) to the outer wall (11o) of the metallurgical vessel (11). Since the rail assembly (3) is configured for guiding the plug/rod assembly with the longitudinal axis (X) being coaxial with the opening axis (X15), the rail fixing elements (13) preferably are distributed over a peripheral circumference of the opening (15). As shown in FIG. 4(a), in general, two rail fixing elements (13) located at diametrically opposed sides of the opening (15) are sufficient for reversibly and rigidly fixing the rail assembly (3) to the outer wall of the metallurgical vessel.

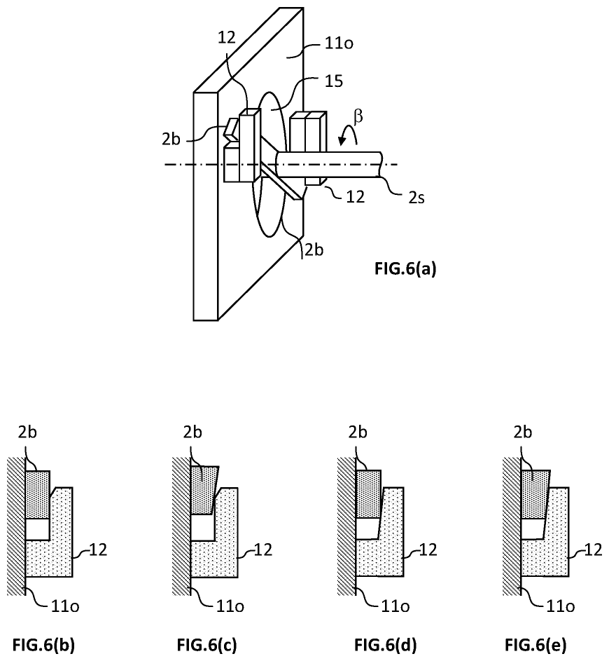

The outer wall (11o) also comprises catcher elements (12) configured for interacting with the at least two locking blades (2b) such as to lock the gas purge plug (1) in the operational position along the opening axis (X15). Like the rail fixing elements (13), two catcher elements (12) can be located at diametrically opposed sides of the openings to interact with the at least two locking blades (2b). More catcher elements (12) can be disposed around the opening (15). Two catcher element (12) as illustrated in FIG. 4(a) are, however, sufficient and simplify the design of the opening periphery. The catcher elements (12) can be L-shaped or T-shaped (cf. FIGS. 4(a) and 6(a) to 6(d)) to receive a corresponding locking blade upon rotation thereof by the plug locking angle (3), like a latch pivoting into a catcher to lock a door (cf. FIGS. 4(c) & 4(d), 5(d) & 5(e), and 6(a) to 6(d)).

### Rail Assembly (3)

The rail assembly (3) is used to guide the plug/rod assembly along the opening axis (X15) until the gas purge plug (1) coated with fresh refractory mortar (15m) reaches the operational position thereof. The rail assembly (3) comprises at least one rail (3r), and wall fixing elements (3f). As shown in FIGS. 4(a) to 4(d), it preferably comprises two rails (3r) parallel to one another. The two rails are mounted such as to maintain during use their positions relative to one another and relative to the outer wall. Each rail extends from a rail coupling end to a rail free end.

The rail assembly comprises wall fixing elements (3f) mating the rail fixing elements (13) of the wall (11w) of the metallurgical vessel (11), located at the rail coupling end and configured for rigidly fixing the rail assembly (3) to the wall (11w) with the at least one rail (3r) extending parallel to the opening axis (X15).

During servicing, the metallurgical vessel (11), typically a ladle (111), is generally pivoted on one side thereof, exposing substantially vertically the bottom floor comprising the opening (15). The outer wall (11o) therefore appears like a substantially vertical wall with the opening axis (X15) extending substantially horizontal. Since the metallurgical vessel is pivoted about hinges, the angular orientation of the opening (15) is always the same for all servicing operations. This knowledge is of course important when designing the wall/rail fixing elements (3f, 13). An example of a simple wall fixing element (3f) collaborating with rail fixing elements (13) to reversibly and rigidly fix the rail assembly (3) to the outer wall (11o) is illustrated in FIGS. 4(a) to 4(d).

Considering the coordinates system (x, y, z) represented in FIG. 4(b), two rail fixing elements (13) are positioned on either side of the opening (15) and are aligned over the y-axis. They are configured for collaborating with two hooks forming the wall fixing elements (3f) of the rail assembly (3). Each rail fixing element (13) comprises a peg extending along the y-axis and attached to a surface of a rest wall extending transversally, preferably perpendicularly out of the outer wall (11o). The surfaces of the two rest walls are separated from one another by the same distance separating the two hooks forming the wall fixing elements (3f) of the rail assembly. This way, no lateral movement of the rail assembly (3) along the y-axis is allowed. The hooks of the rail assembly are configured to engage the pegs, so as to fix the position of the rails along both x- and z-axes. Finally, to restrain the rail assembly from pivoting about the pegs, each wall fixing element (3f) of the rail assembly is provided with a support leg forming a C with the corresponding hook, surrounding the peg when inserted thereon. When loaded on the corresponding rail fixing element (13), the support leg rests on the outer wall by gravity, such that the orientation of the at least one rail (3r) of the rail assembly is set parallel to the opening axis (X15). The position along the y- and z-axes of the rail fixing elements and the design of the wall fixing elements (3f) are dimensioned such that, when the plug/rod assembly is mounted on the rail assembly (3), the longitudinal axis (X) thereof can accurately be brought to be coaxial with the opening axis (X15).

The metallurgical installation also comprises a shuttle (3s), configured for translating along the at least one rail (3r), as shown in FIGS. 4(c) & 4(d) and 5(d) & 5(f). The shuttle comprises a shuttle coupling fixture (32) configured for receiving and coupling to the staff coupling fixture (23) of the staff (2s) of the insertion rod (2). The shuttle coupling fixture (32) preferably allows the staff freedom to rotate about the y-axis at the level of the shuttle coupling fixture (32), from a substantially vertical position wherein the longitudinal axis (X) is substantially perpendicular to the opening axis (X15), to a substantially horizontal position, wherein the longitudinal axis (X) is parallel to the at least one rail (3r) and is coaxial with the opening axis (X15).

The shuttle (3s) is configured for moving by rotation about the y-axis the insertion rod (2) to bring and preferably lock the staff and gas purging plug rigidly coupled thereto to a position wherein the longitudinal axis (X) is coaxial with the opening axis (X15) with the gas purging plug (1) facing the opening (15). The shuttle is also configured for translating the plug/rod assembly along the at least one rail (3r) to insert along the opening axis (X15) the gas purging plug into the opening (15) until reaching the operational position. The operational position along the opening axis (X15) is defined by the at least two locking blades (2b) of the insertion rod contacting the wall (11w) of the metallurgical vessel (11).

It is important that, when the plug/rod assembly is coupled to the shuttle by means of the rod- and shuttle-coupling fixtures (23, 32), the insertion rod (2) can be rotated about the longitudinal axis (X) by a plug locking angle of at least β°≥α. This is easily achieved, such as for example by providing the rod coupling fixture (23) on a sleeve rotatably mounted on the staff (2s) of the insertion rod (2) and prevented from translating along the longitudinal axis (X), as shown in FIGS. 4(a) to 4(d). Rotation of the insertion rod about the longitudinal axis (X) is required, on the one hand,
once the gas purge plug has reached the operational position to engage the at least two locking blades (2b) into the catcher elements (12) and thus reversibly lock the gas purging plug (1) at the operational position and, on the other hand,
to remove the insertion rod (2) from the gas purge plug once the latter is fixed at the operational position in the opening by the setting of the refractory mortar.
   Method for Fixing a Gas Purging Plug (1) into an Opening (15)

The present invention also concerns a method for inserting a gas purging plug (1) as defined supra into an opening (15) in a wall (11) of a metallurgical vessel (11), such as a ladle (111) (cf. FIG. 1(a)). As shown in FIG. 4(a), the method requires the use of,
a metallurgical vessel (11) comprising an opening extending through a wall (11w) thereof from an outer wall (11o) to an inner wall (11i), wherein the outer wall (11o) is equipped with catcher elements (12) and with rail fixing elements (13) disposed around the opening (15) as discussed supra and illustrated in FIG. 4(a),
a gas purge plug (1) as discussed supra,
an insertion rod (2) as discussed supra,
a rail assembly (3) as discussed supra.

The rail assembly (3) is rigidly fixed to the wall (11w) by engaging the wall fixing elements (3f) into the rail fixing elements (13) of the wall (11w) of the metallurgical vessel (11) (cf. FIG. 4(a)). As shown in FIGS. 4(b) to 4(d), the at least one rail (3r) is parallel to the opening axis (X15). Once fixed, the rail assembly must not move during the whole insertion and fixing operations of the new gas purge plug (1). After the new gas purge plug is fixed to the operational position, the rail assembly (3) can be removed from the outer wall (11o) of the metallurgical vessel (11). Since no hydraulic piston or compressed air hammer is used, the rail assembly is light-weight and easy to handle for both fixing it to the outer wall (11o) and for removing it therefrom.

The plug/rod assembly is formed by rigidly coupling the gas purging plug (1) to the insertion rod (2) with the plug axis (X1) coaxial with the rod axis (X2) defining the longitudinal axis (X), by first translating and then rotating by the rod coupling angle α the rod coupling element (2c) relative to the plug coupling element (1c) (cf. FIGS. 2(d), 2(e), and 3(a) to 3(c)). The insertion rod (2) is used by the operator for handling the gas purge plug and the rigid connection between the two allows moving the gas purge plug inter alia by translation along and by rotation about the longitudinal axis (X).

As shown in FIGS. 4(a) and 5(b), the staff (2s) of the insertion rod (2) is coupled to the shuttle by engaging the rod coupling fixture (23) of the insertion rod (2) and the shuttle coupling fixture (32) of the shuttle (3s). The plug/rod assembly is thus centred along the y-axis with the opening (15). The plug/rod assembly preferably has the longitudinal axis (X) forming an angle of at least 60° with, preferably substantially perpendicular to the opening axis (X15) when it is being coupled to the shuttle (2s). This way, the plug/rod assembly is in an optimal position for the operator to coat an external surface of the elongated body of the gas purge plug with fresh refractory mortar (15m) as shown in FIG. 5(b). The fresh refractory mortar (15m) can be applied to the external surface of the elongated body before coupling the plug/rod assembly, but once coated with fresh refractory mortar, the plug/rod assembly is heavier and more cumbersome to handle, than if the mortar is applied after the plug/rod assembly has been fixed to the shuttle. It is preferred that the plug/rod assembly can be coupled to the shuttle with the longitudinal axis (X) substantially perpendicular to the opening axis (X15) (i.e., substantially vertical), as it is easier to hold the plug/rod assembly upon applying the fresh refractory mortar in a vertical position, fixed at one point.

FIGS. 5(b) and 5(c) show how the plug/rod assembly is pivoted about the y-axis to bring the plug/rod assembly to a position wherein the longitudinal axis (X) is coaxial with the opening axis (X15) and wherein the gas purging plug (1) faces the opening (15). The purge/rod is preferably locked in that position relative to the shuttle (3s). The locking mechanism can simply be a stop; preventing the plug/rod assembly from rotating any further, driven by the heavy weight of the gas purge plug coated with fresh refractory mortar (15m). With the longitudinal axis (X) coaxial with the opening axis (X15), the gas purge plug (1) can be moved into the opening in an accurately centred position relative to the opening. This is carried out in the following way.

As shown in 4(b), 4(c), and 5(d), the shuttle (3s) is translated along the at least one rail (3r) to insert along the opening axis (X15) the gas purging plug into the opening (15). This operation requires little force and can be carried out by a human operator by simply pushing the insertion rod (2) and shuttle (3s) along the at least one rail (3r). The translation does not stop until the at least two locking blades (2b) of the insertion rod contact the wall (11w) of the metallurgical vessel (11) surrounding the opening (15). This way, the gas purge plug has reached the operational position with great accuracy, on the one hand, in the plane (y, z) by coupling the plug/rod assembly to the shuttle (3s) and bringing the longitudinal axis (X) coaxial with the opening axis (X15) and, on the other hand, along the x-axis, which position is defined when the at least two locking blades contact the outer wall (11o).

The insertion rod (2) is rotated about the longitudinal axis (X) by a plug locking angle of up to β°≥α, to engage the at least two locking blades (2b) into the catcher elements (12) and thus reversibly lock the gas purging plug (1) in the operational position. This rotation of the plug/rod assembly about the longitudinal axis (X) explains why the staff must be allowed to rotate about the longitudinal axis (X) relative to the staff coupling fixture (23), since the latter, which is coupled to the shutter coupling fixture (32), is not allowed to rotate about the longitudinal axis (X).

The catcher elements define an open space between the outer wall (11o) and a wall of the catcher element. As shown in FIGS. 4(d), 5(e), and 6(a), the rotation of the plug/rod assembly by the plug locking angle β when the locking blades (2b) contact the outer wall (11o) engages them into the open space of the corresponding catcher elements (12) in the same way as a latch engaging a catcher locks a door. The open space can be straight with locking blades (2b) having a rectangular cross-section mating the straight open space (cf. FIG. 6(b)) or with locking blades (2b) having a tapered cross-section (cf. FIG. 6(c)). The open space can be tapered, and the locking blades (2b) can have a rectangular cross-section (cf. FIG. 6(d)), or preferably the locking blades have a tapered cross-section (cf. FIG. 6(e)), with the leading edge penetrating first into an open space being thinner than the trailing edge penetrating last in the open space. A tapered open space and/or locking blade cross-section is advantageous in that the locking forces of the plug/rod assembly along the longitudinal axis increases as the rotating locking blades (2b) engage like wedges deeper into the open space.

As shown in FIGS. 5(d), 5(e) and 6(a) to 6(d), two locking blades (2s) at 180° suffice to lock the plug/rod assembly along the longitudinal axis (X) at the operational position. Three or, as illustrated in FIGS. 4(a) to 4(d), preferably four locking blades (2b) extending over a plane normal to the longitudinal axis (X), however, are advantageous in that the contact of all three or four locking blades with the outer wall ensure an optimal alignment of the longitudinal axis (X) with the opening axis (X15).

Without rotating the plug/rod assembly to engage the locking blades (2b) into the corresponding catcher elements (12), the gas purge plug (1) would tend to move out of the opening (15) driven by the fresh refractory mortar (15m) being squeezed in the gap defined between the elongated body and the wall of the opening. An operator would have to keep some pressure on the plug/rod assembly to maintain it at the operational position until the refractory mortar (15m) sets after a few minutes. Besides the tediousness and lack of added value of such operation, application of a pressure by a human operator is a source of variations of the final position of the gas purge plug between two such operations, affecting the reproducibility of the positioning of the gas purge plug in the wall (11) of the metallurgical vessel.

The refractory mortar (15m) is allowed to set without any further human action. Setting of the refractory mortar can take from 2 to 10 min, preferably around 3 to 6 min. When the refractory mortar (15m) is set, the insertion rod (2) can be removed from the gas purge plug (1). This is achieved by rotating the insertion rod (2) in the opposite direction as for locking, by a plug unlocking angle −β, to disengage the at least two locking blades (2b) from the catcher elements (12). Since the gas purge plug (1) is rigidly fixed at the operational position in the opening by the set refractory mortar (15m), it cannot rotate together with the insertion rod (2), and the rotation of the latter by the plug unlocking angle −β whose absolute value is larger than or equal to the rod coupling angle α (i.e., β°≥α) also has the effect of decoupling the insertion rod (2) from the gas purging plug (1) which is fixed to the operational position by the refractory mortar (15m).

The rail assembly can be removed very easily by disengaging the wall fixing elements (3f) of the rail assembly from the rail fixing elements (13). This way, both insertion rod (2) and rail assembly (3) can be removed, and the gas purge plug is ready for use, rigidly fixed at the operational position in the opening (15).

A gas tube (1t) can be coupled to the gas inlet (1i) of the gas purge plug (1) to supply gas from a gas source (1s) as known in the art, to sparge gas bubbles (1g) into the metal melt (21) contained in the metallurgical vessel (11).

### Concluding Remarks

The present invention is a simple and easy-to-use solution for reproducibly and easily positioning a gas purge plug into an opening (15) of a wall (11w) of a metallurgical vessel (11) and for fixing it at the operational position. The present invention does not require any heavy or bulky equipment like a hydraulic piston. The rail assembly (3) is therefore quite light and easy to handle and quick to fix and remove from the outer wall (11o) by a single operator.

The locking blades (2b) have multiple advantages. First, upon contacting the outer wall (11o), they accurately define the depth along the longitudinal axis (X) of the operational position of the gas purge plug (1). Second, as they extend over a plane normal to the longitudinal axis (X), their contacting the outer wall (11o) also ensures that the plug axis (X1) is parallel to the opening axis (X15) and that the gas purge plug is not tilted relative to the opening (15). Finally, by engaging the locking blades (2b) into the carrier elements (12), the gas purge plug (1) cannot move anymore along the longitudinal axis (X) and the mortar can be allowed to set without any further human intervention. Absent the locking blades engaged in the catcher elements, the gas purge plug would move out of the opening along the longitudinal axis under the effect of the fresh refractory mortar squeezed in the gap separating the wall of the opening from the surface of the elongated body.

Removing the insertion rod (2) and rail assembly once the refractory mortar has set is very easy. No superstructure is left attached to the outer wall (11o) after the operation is completed and the metallurgical vessel (11) can be pivoted back to its working position, filled with molten metal (21) and gas can be sparged through the gas purge plug (1) by coupling a gas tube (1t) between the gas inlet (1i) and a gas source (1s).

| Ref # | Definition |
|---|---|
| 1 | Gas purging plug |
| 1c | Plug coupling element |
| 1f | Transverse slit in female element of bayonet |
| | type plug coupling element |
| 1g | Gas bubble |
| 1i | Gas inlet |
| 1k | Protrusion in male element of key-lock type |
| | plug coupling element |
| 1o | Gas outlet |
| 1s | Gas source |
| 1t | Gas tube between gas source and plug inlet |
| 2 | Insertion rod |
| 2b | Locking blade |
| 2c | Rod coupling element |
| 2f | Protrusion in male element of bayonet type |
| | plug coupling element |
| 2k | Recess in female element of key-lock type |
| | plug coupling element |
| 2s | Staff |
| 3 | Rail assembly |
| 3f | Wall fixing element |
| 3r | Rail |
| 3s | Shuttle |
| 11 | Metallurgic vessel |
| 11i | Inner wall |
| 11o | Outer wall |
| 11w | Wall of metallurgic vessel |
| 12 | Catcher element |
| 13 | Rail fixing element |
| 15 | Opening |
| 15m | Refractory mortar |
| 21 | Metal melt |
| 23 | Staff coupling fixture |
| 32 | Shuttle coupling fixture |
| 111 | Ladle |
| 112 | Tundish |
| 113 | Mould |
| X | Longitudinal axis (when X1 coaxial with X2) |
| X1 | Plug axis |
| X2 | Rod axis |
| X15 | Opening axis |
| a | rod coupling angle for rigidly coupling the |
| | insertion rod to the gas purging plug |
| b/−b | Plug locking/unlocking angle for reversibly |
| | locking/unlocking the gas purging plug in/out |
| | of the operational position |

1. A kit-of-parts for installing a gas purging plug into a metallurgical vessel comprising:
a gas purging plug (1) for blowing gas into a metallurgical vessel (11) comprising:
an elongated body made of a refractory material, inscribed in a volume of revolution about a plug axis (X1), wherein the elongated body extends from an inlet end comprising a gas inlet (1i) to an outlet end comprising a gas outlet (1o) and
at least one gas flow path fluidly connecting the gas inlet (li) to the gas outlet;
an insertion rod (2);
at least two locking blades (2b) extending normal to the longitudinal axis at a predefined distance from the coupling end; and
the insertion rod (2) is configured for being rotated by a plug locking angle up to β°, to engage the at least two locking blades (2b) into catcher elements (12) of the metallurgical vessel (11) and thus reversibly lock the gas purging plug in the operational position;
characterized in that
the gas purging plug (1) comprises a plug coupling element (1c) located at the inlet end, coaxial with the plug axis (X1) and configured for forming a rigid mechanical coupling with a mating rod coupling element (2c),
the plug coupling element (1c) is configured for forming the rigid mechanical coupling with the mating rod coupling element (2c) by rotation of one relative to the other about the plug axis (X1) by a rod coupling angle, 5≤°α≤80°,
the insertion rod (2) comprises:
an elongated staff (2s) extending from a staff coupling end to a staff second end along a rod axis (X2),
a rod coupling element (2c) located at the staff coupling end and configured for mating the plug coupling element (lc) to form a purge/rod assembly comprising the insertion rod (2) rigidly coupled to the gas purging plug (1) with the rod coupling element (2c) rigidly and reversibly mechanically coupled to the plug coupling element (1c),
the at least two locking blades (2b) are distributed around a circumference of the elongated staff,
the rod coupling element (2c) and the plug coupling element (lc) are configured for rigidly coupling and decoupling to and from one another with the plug axis (X1) being coaxial with the rod axis (X2) defining a longitudinal axis (X), by first a translation of one relative to the other along the longitudinal axis (X) followed by a rotation about the longitudinal axis by a rod coupling angle, 5≤α≤80°,
the insertion rod (2) comprises the at least two locking blades (2b), and
the plug locking angle is β°≥α.

2. The kit-of-parts, according to claim 1, wherein the rod coupling element (2c) and the plug coupling element (1c) comprise a male element and a female element, wherein
the male element comprises a base of geometry of revolution about the longitudinal axis (X) and
the female element comprises a cavity of geometry of revolution about the longitudinal axis (X) with a first radius mating the base of the male element, and configured for accepting introduction of the male base into the cavity,
and wherein the rod coupling element (2c) and the plug coupling element (1c) are of one of the following types,
a key-lock type, wherein
the base of the male element is provided with protrusions (1k) distributed about a circumference of the base, defining a key, the protrusions having a protrusion thickness measured along the longitudinal axis (X), and wherein
the cavity of the female element comprises recesses (2k) located at an opening of the cavity and mating the corresponding protrusions (1k) of the male element, and a circumferential channel (2c) located deeper in the cavity along the longitudinal axis (X), beyond the recesses, the channel having a second radius, larger than or equal to a sum of the first radius and of a radial dimension of any recess and having a channel thickness measured along the longitudinal axis (X) which is larger than or equal to the protrusion thickness, the female element forming a lock configured for allowing insertion of the male element into the cavity for a finite number of angular positions wherein the protrusions of the male element are in registration with corresponding recesses of the female element, until the protrusions reach the channel and for allowing a rotation by the rod coupling angle, α, of the male element relative to the female element such as to bring the protrusions out of registration from the recesses to rigidly and reversibly mechanically couple the rod coupling element (2c) to the plug coupling element (1c), or
a bayonet type, wherein
the base of the male element is provided with a number of protrusions (2f) aligned along the longitudinal axis (X), and wherein,
the cavity of the female element comprises a longitudinal slit extending parallel to the longitudinal axis (X) and is configured for receiving in a sliding relation the number of protrusions (2k) and comprises a number of transverse slits (if) at least equal to the number of protrusions, starting from the longitudinal slit and extending parallel to one another and transversally to the longitudinal axis (X), the female element being configured for allowing insertion of the male element into the cavity with the number of protrusions sliding along the longitudinal slit, until each of the number of protrusions reaches the corresponding number of transverse slits and for allowing a rotation by the rod coupling angle, α, of the male element relative to the female element such as to insert the number of protrusions along the corresponding transverse slits to rigidly and reversibly mechanically couple the rod coupling element (2c) to the plug coupling element (1c).

3. The kit-of-parts according to claim 1, wherein the insertion rod (2) comprises three or four locking blades (2b).

4. A metallurgical installation comprising:
a kit-of-parts according to claim 1,
a metallurgical vessel (11) comprising a wall (11w) comprising an inner wall (11i) separated from an outer wall (11o) by a thickness of the wall, wherein
the wall comprises an opening (15) extending along an opening axis (X15) from the outer wall (11o) to the inner wall (11i) and configured for introducing the elongated body of the gas purge plug (1) into the opening (15) by the outer wall, and for accommodating and rigidly fixing the gas purge plug (1) at an operational position with the plug axis (X1) coaxial with the opening axis (X15), and maintained in the operational position with a refractory mortar (15m),
on at least two sides of the opening (15), the outer wall comprises the catcher elements (12) configured for interacting with the at least two locking blades (2b) such as to lock the gas purge plug (1) in the operational position along the opening axis (X15).

5. The metallurgical installation according to claim 4, wherein the number of catcher elements (12) on the outer wall is lower than the number of locking blades (2b) on the insertion rod.

6. The metallurgical installation according to claim 4, wherein on at least two sides of the opening, the outer wall comprises rail fixing elements (13) configured for reversibly receiving and rigidly holding in place a rail assembly (3), wherein the metallurgical installation comprises:
the rail assembly (3), which comprises,
at least one rail (3r), each of the at least one rail extending from a rail coupling end to a rail free end, and
wall fixing elements (3f) mating the rail fixing elements (13) of the wall (11w) of the metallurgical vessel (11), located at the rail coupling end and configured for rigidly fixing the rail assembly (3) to the wall (11w) with the at least one rail (3r) extending parallel to the opening axis (X15), and
a shuttle (3s) comprising a shuttle coupling fixture (32) configured for receiving and coupling the staff (2s) of the insertion rod (2), the shuttle (3s) being configured for:
moving the insertion rod (2) to bring the staff and gas purging plug rigidly coupled thereto to a position wherein the longitudinal axis (X) is coaxial with the opening axis (X15) with the gas purging plug (1) facing the opening (15), and
for translating along the at least one rail (3r) to insert along the opening axis (X15) the gas purging plug into the opening (15) until reaching the operational position, with the at least two locking blades (2b) of the insertion rod contacting the wall (11w) of the metallurgical vessel (11).

7. The metallurgical installation according to claim 6, wherein the shuttle coupling fixture (32) is configured to allow the staff to rotate from a position wherein the longitudinal axis (X) is substantially perpendicular to the opening axis (X15), to a position wherein the longitudinal axis (X) is parallel to the at least one rail (3r) and is coaxial with the opening axis (X15).

8. The metallurgical installation according to claim 7, wherein the shuttle coupling fixture (32) is coupled to a staff coupling fixture (23) of the staff is such a way that, in the position wherein the longitudinal axis (X) is substantially perpendicular to the opening axis (X15), the staff is hung by the shuttle coupling fixture (32).

9. The metallurgical installation according to claim 6, wherein the shuttle (3s) comprises at least one sleeve surrounding the at least one rail (3r) in such a way that the shuttle (3s) may slide along the at least one rail (3r) during the translation.

10. The metallurgical installation according to claim 6, wherein the rail fixing elements (13) and the rail assembly (3) are such that the at least one rail (3r) does not move during the translation of the shuttle (3s).

11. A method for inserting a gas purging plug (1) into an opening (15) extending along an opening axis (X15) from an outer wall (11o) to an inner wall (11i) of a metallurgical vessel (15), and for reproducibly positioning and fixing the gas purging plug (1) to an operational position in the gas purging plug (1), comprising
providing a metallurgical installation according to claim 4,
forming a plug/rod assembly by rigidly coupling the gas purging plug (1) to the insertion rod (2) with the plug axis (X1) coaxial with the rod axis (X2) defining the longitudinal axis (X), by first translating and then rotating by the rod coupling angle α the rod coupling element (2c) relative to the plug coupling element (1c),
applying the refractory mortar (15m) to an external surface of the elongated body of the gas purging plug (1),
moving by rotation the plug/rod assembly to bring the plug/rod assembly to a position wherein the longitudinal axis (X) is coaxial with the opening axis (X15) with the gas purging plug (1) facing the opening (15),
inserting along the opening axis (X15) the gas purging plug into the opening (15) until the at least two locking blades (2b) of the insertion rod contact the wall (11w) of the metallurgical vessel (11), thus defining the operational position,
rotating the insertion rod (2) about the longitudinal axis (X) by a plug locking angle of up to β°≥α, to engage the at least two locking blades (2b) into the catcher elements (12) and thus reversibly lock the gas purging plug (1) in the operational position,
allowing the refractory mortar (15m) to set,
rotating the insertion rod (2) by a plug unlocking angle −β, to disengage the at least two locking blades (2b) from the catcher elements (12) and to decouple the insertion rod (2) from the gas purging plug (1) which is fixed to the opening (15) at the operational position by the refractory mortar (15m).

12. The kit-of-parts-according to claim 1, wherein the rod coupling angle is 10°≤α≤75°.

13. The kit-of-parts-according to claim 2, wherein the key-lock type is present and, further comprising protrusions (1k) distributed along the longitudinal axis (X).

14. The metallurgical installation according to claim 6, wherein the at least one rail (3r), is two rails (3r) parallel to one another.

15. The metallurgical installation according to claim 6, wherein the shuttle (3s) being further configured for: locking the staff and gas purging plug rigidly coupled thereto to a position wherein the longitudinal axis (X) is coaxial with the opening axis (X15) with the gas purging plug (1) facing the opening (15).

16. The method according to claim 11, further comprising locking by rotation the plug/rod assembly in the position wherein the longitudinal axis (X) is coaxial with the opening axis (X15) with the gas purging plug (1) facing the opening (15).
